(19) United States
(12) Patent Application Publication
(10) Pub. No.: US 2026/0205470 A1
(43) Pub. Date: Jul. 16, 2026

(54) METHOD FOR MONITORING A TECHNICAL SYSTEM WITH REGARD TO A POTENTIALLY SAFETY-RELEVANT SITUATION

(71) Applicant: Robert Bosch GmbH, Stuttgart (DE)

(72) Inventors: Dominik Germek, Berlin (DE); Christopher Huth, Heilbronn (DE); Martin Ring, Lossburg (DE); Andreas Heyl, Weil Der Stadt (DE); Christoph Boesch, Kirchentellinsfurt (DE); Peter Schneider, Holzgerlingen (DE)

(21) Appl. No.: 19/445,836

(22) Filed: Jan. 12, 2026

(30) Foreign Application Priority Data
Jan. 16, 2025 (DE) 10 2025 101 393.4

(51) Int. Cl. H04L 9/40

(52) U.S. Cl. CPC H04L 63/1416

(57) ABSTRACT

A method for monitoring a technical system, in particular a vehicle, with regard to a potentially safety-relevant situation, including: determining available context parameter values for at least a portion of the context parameters comprised by the context parameter data; determining, based on the context-parameter attack decompositions, active context-parameter attack decompositions; determining, based on the context parameter situation data and the available context parameter values, safety-relevant situations that are relevant for the active context-parameter attack decompositions; determining, based on the response data and the relevant safety-relevant situations, at least one measure; and providing information regarding the at least one measure and, in particular, initiating the at least one measure.

### FIELD

The present disclosure relates to a method for monitoring a technical system, in particular a vehicle, with regard to a potentially safety-relevant situation, and also to a computing unit and to a computer program for performing the method.

### BACKGROUND INFORMATION

Safety and security can be combined with one another, wherein one discipline influences the other. In the automotive field, the combination of safety and security, e.g., is particularly important, since a security attack can lead to a safety-relevant incident.

### SUMMARY

The present disclosure provides a method, in particular a computer-implemented method, for monitoring a technical system, along with a computing unit and a computer program for performing said method, with the features of the independent claims. Advantageous example embodiments are disclosed herein.

The present disclosure is concerned with the monitoring of technical systems with regard to potentially safety-relevant situations, along with the recognition thereof and measures therefor. In particular, the present disclosure relates to the aspects of “safety” and “security” and their relationship to each other. The German term “Sicherheit” is frequently translated as both aspects, “safety” and “security”, where the term “safety” will hereinafter be used as a general concept to refer to both aspects. In order to ensure a distinction, hereinafter the aspect “safety” is, where appropriate, to be referred to as “operational safety” (this pertains to protecting the environment from an object, in the sense of accident prevention), whereas the aspect “security” will remain as is (this pertains to protecting an object from the environment, in the sense of burglary protection or protection against unauthorized use).

Operational safety and security have long been combined with one another, wherein one discipline influences the other. In the automotive field, the combination of operational safety and security is particularly important, since a security attack can lead to a safety-relevant incident (in the sense of operational safety). This fact is also taken into account, e.g., in a regulation regarding general product safety.

In a (safety or security) threat analysis and risk assessment (TARA), typically only general attack conditions are taken into account, and smaller safety-relevant attacks are later discarded. For example, an attacker could start an attack when the windshield wipers are activated and washer fluid is sprayed. Such an attack, in itself, is not critical. However, if the attack is started in a safety-relevant context (in the sense of operational safety), e.g., when the vehicle is traveling at high speed and the road is slippery (e.g., if an attacker has access to the location of the vehicle via GPS or starts the attack via an access point installed along the road), the attack could lead to a safety-relevant incident or a safety-relevant situation.

Within the framework of the present disclosure, a possibility is provided for closing the gap arising here. In particular, an (automatic) recognition is to be made possible as to whether a (cyber) security attack is likely to lead to a safety-relevant (operational-safety-relevant) and potentially hazardous situation in a vehicle during operation.

Although the present disclosure is described hereinafter for improved explanation, in particular in relation to vehicles, it can, however, also be used with other technical systems such as, e.g., components or control units of a vehicle, a robot or a control unit of a robot, a building, in particular a factory or a hospital, a smart home, or a smart locality or smart city. For vehicles themselves, passenger cars, trucks and other vehicles such as motor trucks or buses are also contemplated, as well as vehicles on water and in the air (thus, e.g., ships, boats and airplanes or helicopters).

Hereinafter, various terms used within the framework of the present application are initially briefly explained.

Function block: A function block is the smallest meaningful functional part of a software package or piece of software, which part is represented, or can be represented, in a broken-down or decomposed manner. A function block could, for example, be a function or a number of functions that implement a specific behavior. In particular, it is proposed to represent function blocks in the form of textual (and thus human-readable) descriptions. An example of a function block could be a function that executes the following action: “Connect to the remote server using a protocol such as FTP or SFTP.”

Functional area: A functional area is a functional area (or region) of a group of function blocks that are related to one another and implement a specific, more complex behavior. For example, a functional area could be a group of function blocks that carry out an attack, e.g., pass confidential information to a remote server. The functional area that represents this attack could thus consist of the following function blocks:
1) Turn off logging.
2) Open the desired local file in read mode.
3) Read the content of the file.
4) Connect to the remote server using a protocol such as FTP or SFTP.
5) Open a file on the remote server in write mode.
6) Write the content read from the local file to the remote file.
7) Close the remote file.
8) Close the local file.
9) CONTINUE LOGGING.

Decomposition: A decomposition is the entire software (i.e., for example, a software package) that is represented in the form of connected function blocks.

In the proposed approach, context parameter data are provided that comprise a plurality of context parameters (or context-related parameters) that are related to a context of the technical system. These can be, for example, parameters that describe the context of a vehicle (as a technical system). Concrete examples thereof are driving speed, steering angle, weather data (is it raining, snowing, foggy, etc.), geolocation of the vehicle (is it on a highway, in a city, in a tunnel, near a school, near a sharp curve, etc.), driver data (experience, duration of the last steering time, health status, fatigue, etc.), status of vehicle components (is the windshield washer fluid full or being dispensed, what is the engine speed, are low-beam and high-beam switched on or off, are the turn signals activated, is the battery charged, is the vehicle braking and how strongly, etc.), statistics on accidents by location, status of actuators (is the braking system functioning, is the steering system functioning, when was it last serviced, etc.), interior temperature, humidity, volume of loudspeakers, type of music being played (e.g., aggressive or relaxing), etc. (e.g., in order to establish how comfortable the driver is). For other technical systems, other or comparable parameters are correspondingly contemplated.

According to the present disclosure, the context parameters can be collected based on human inputs, online resources, analysis of the vehicle sensors or generally sensors of the technical system, internal vehicle systems or generally internal system or components of the technical system, specifications, weather services, traffic services and the like. Each context parameter should be uniquely identifiable and represented in a structurally readable format such as text, XML, JSON or others. The context parameters or the context parameters can be stored in a database. It is noted here that this pertains only to the parameter definition (e.g., “driving speed”), and not to the actual values of the context parameter (e.g., “100 km/h”).

Furthermore, context parameter situation data are provided that comprise assignments between context parameters and hazardous situations (or hazard situations). A hazard situation is, in particular, a situation that can potentially lead to a safety-relevant (related to operational safety) incident in a vehicle or technical system and is typically derived and documented in a so-called “hazard analysis and risk assessment” (e.g., for motor vehicle systems). A hazard situation could read, for example: “The vehicle is traveling at high speed and the brakes are disabled.” Another hazard situation could read: “The vehicle is traveling at high speed and is approaching a sharp curve under poor visibility conditions, and the windshield wipers are spraying washer fluid in an uncontrolled manner.” In both cases, the situations could lead to an accident (safety-relevant incident). For these specific hazard situations, at least the following context parameters are relevant, e.g.: “driving speed,” “status of the brakes,” “status of the windshield wipers” and “weather conditions.” The assignment of context parameters to hazard situations can be carried out manually or by collecting data from existing sources (websites, Statistics, LLMs and others).

Furthermore, context-parameter attack data are provided that comprise a plurality of context-parameter attack decompositions. The context-parameter attack decompositions in each case correspond to an attack decomposition to which one or more context parameters are, or have been, assigned. The attack decompositions in turn in each case comprise one or more of the function blocks obtained, or having been obtained, by decomposing an attack vector.

An attack vector is, in particular, a description of how an attacker can exploit a vulnerability in a component in order to perform a malicious action. Examples of attack vectors are: “an attacker can exploit a vulnerability in the control unit in order to disable the brakes,” “an attacker can exploit a vulnerability in the control unit in order to control the windshield wipers and the dispensing of washer fluid,” or “an attacker can obtain remote access to the infotainment system in order to control the volume of the loudspeakers.” The attack vectors can originate from various sources, e.g., threat databases, databases of security gaps, security reports, Internet forums, the deep web, honeypot data and others. The content of the attack vectors can be represented in any desired, structurally readable format, e.g., as text, XML, JSON or another format. For example, the attack vector “an attacker can exploit a vulnerability in the control unit in order to control the windshield wipers and the dispensing of washer fluid” could be represented as text describing the steps an attacker must perform in order to control the windshield wiper (with any level of detail).

The attack vectors can be collected in various ways, including a manual description by a security expert, an automatic extraction from the aforementioned sources via parsers, crawlers, or even by querying LLMs. The result of this sub-step is a set of attack vectors describing how an attacker can exploit vulnerabilities in the components of a vehicle or technical system in order to perform stored malicious actions. Here, the attack vectors relate not only to software vulnerabilities, but also to hardware, sensors, actuators and other components of a vehicle or generally of a technical system.

According to an example embodiment, the attack vectors collected in this way can then be decomposed or translated into decompositions (attack decompositions). A decomposition is, in particular, a structured representation of an attack vector, which representation consists of function blocks (i.e., a set of minimal steps describing the attack process). A decomposition would thus be a structured set of steps for performing, for example, the attack vector “an attacker can exploit a vulnerability in the control unit in order to control the windshield wipers and the dispensing of washer fluid.” The result of this sub-step is a plurality of attack decompositions.

It is also possible to filter out relevant attack decompositions, although this is optional. This can be performed in order to focus on the most relevant attacks based on the vehicle and driver context (or generally of the technical system) and the general driving requirements or requirements (e.g., which vehicle is affected, what it is used for, and who drives it where). Furthermore, filtering can lead to lower memory consumption and faster processing. The result of this sub-step is then a filtered plurality of attack decompositions.

The representation of the decomposition is carried out, in particular, as, or using, a so-called decomposition-based control flow graph (DCFG). A control flow graph (CFG) is a data structure in computer science used, e.g., in compilers. Here, the target software can be decomposed into a CFG, in which each basic block (a basic block is a straight-line code sequence with no branches into it except at the entry and no branches out of it except at the exit) is represented as a collection of function blocks. A functional area can contain one or more basic blocks within the DCFG, depending on which functionality is reflected in the CFG. The function blocks are, in particular, represented as human-readable descriptions. The functional areas are thus groups of function blocks implementing a particular behavior.

Each or at least some of the attack decompositions can then in each case be assigned one or more context parameters. The context parameter attack decompositions are thus obtained. A context-parameter attack decomposition is, in particular, a structured representation of an attack decomposition that is enriched with context parameters. Here, the term “enriched” refers to identifying the function blocks in attack decompositions that are related to (or influence) the collected context parameters. For example, the attack decomposition describing the attack steps “an attacker can exploit a vulnerability in the control unit in order to disable the brakes” is related to the context parameter “brake Status” (along with, if applicable, further ones). The context-parameter attack decompositions thus describe how an attack can potentially lead to an influence on context parameters. As before, the linking or assignment between an attack decomposition and context parameters can be performed manually or by collecting data from available sources (websites, statistics, LLMs and others).

Furthermore, response data are provided that comprise a plurality of response decompositions. The response decompositions in each case comprise one or more of the function blocks obtained, or having been obtained, by decomposing a response to a safety-relevant situation at the technical system.

A response decomposition is, in particular, a structured representation of a response measure (response) that can be taken in order to prevent a safety-relevant incident (or situation) in a vehicle or other technical system. A response decomposition could read, for example: “If the brakes are disabled, the vehicle should automatically reduce the speed to 0 km/h by controlled engine braking.”

For this purpose, a series of responses or response measures can initially be collected. A response or response measure is a description of how to respond to a safety-relevant incident in a vehicle. The response measures can be collected from various sources, e.g., safety manuals, best practices, safety reports, threat data, IDPS reports and others. The content of the response measures is, in particular, represented in any desired, structurally readable format, e.g., as text, XML, JSON or others. The result of this sub-step is response measures describing how to respond to potentially safety-relevant incidents in a vehicle.

These responses or response measures can then be decomposed in order to obtain the response decompositions. Here, the already mentioned concept of decomposition can be used. A response decomposition is thus, in particular, a structured representation of a response or response measure composed of function blocks (a set of minimal steps describing the response).

Based on the cited data, i.e., context parameter data, context parameter situation data, context-parameter attack data, and context-parameter attack data, the actual monitoring of the technical system can then be carried out. Collecting and, if applicable, generating the cited data does not need to be carried out in the cited order and can also be carried out repeatedly, in the sense of an update. In particular, it is important that these data are available and that they can be used for the monitoring.

Available context parameter values are determined for at least a portion of the context parameters comprised by the context parameter data. For this purpose, all available context parameter values from the vehicle, driver and other sources (e.g., Internet and IDPS)—or generally from and/or related to the technical system—can be collected. This is carried out based on the context parameters of the context parameter data. Specifically, this pertains to the (current) values of these context parameters. Depending on the type of the context parameters, some values can, e.g., already be retrieved in advance (e.g., the weather forecast) or predicted (e.g., position at a specified point in time based on routes and map information). The context parameter values are the actual values of the context parameters describing the context in which, e.g., a vehicle is driving or will drive.

An example thereof is, e.g., the following context (context parameter values for certain context parameters):
Driving speed: 150 km/h (reported by the sensors of the vehicle);
Location: context parameter value indicates that a “sharp curve is upcoming” (reported by the GPS of the vehicle);
Weather: context parameter value indicates that “it has rained, the road is slippery,” and “poor visibility due to fog” (reported by the weather service);
Break-in status: indicates that “someone could have access to the control unit and/or the infotainment system” (reported by the IDPS of the vehicle).

In one example embodiment, it can also be provided that the context parameter values obtained in this way are filtered in order to obtain the available context parameter values. This allows focusing on the most relevant attacks based on the context and the driving requirements of the vehicle and the driver (in the example of the vehicle as the technical system), and focusing on the objective of minimizing memory usage and processing time.

Furthermore, active context-parameter attack decompositions are determined. This is carried out, in one embodiment, in that it is determined which of the context-parameter attack decompositions can be assigned to the available context parameter values in order to obtain the active context-parameter attack decompositions. Here, the detected context parameter values are thus matched with the corresponding context-parameter attack decompositions. The matching is carried out, in particular, in that it is checked which context-parameter attack decompositions are connected to the available context parameters (these are then those context parameters for which context parameter values are available). These context-parameter attack decompositions are then classified as “active.” Here, the active context-parameter attack decompositions are thus assignable and hence currently relevant context-parameter attack decompositions.

Alternatively, an assessment in steps, e.g., from 0 to 10, is also possible, for example, wherein a threshold value establishes which context-parameter attack decompositions are active or are to be regarded as active. Here as well, the active context-parameter attack decompositions are current relevant context-parameter attack decompositions.

For example, the context parameter value “Wiper status: dispensing” is assigned to the context-parameter attack decomposition that describes the attack “The vehicle is approaching a sharp curve at high speed and under poor visibility conditions, and the windshield wipers were dispensing washer fluid in an uncontrolled manner.” In particular, in determining the active context-parameter attack decompositions, it is important to further consider those that are regarded as currently relevant.

Based on the context parameter situation data and the available context parameter values, safety-relevant situations that are relevant for the active context-parameter attack decompositions are then determined. The hazard situations (from the context parameter situation data) are the potentially safety-relevant incidents or situations that can occur when the context-parameter attack decompositions are realized in combination with other context parameter values. A relevant (or “active”) hazardous situation (or hazard situation) is thus, in particular, one whose probability of occurrence is greater than 0.

For example, the hazard situation for the active context-parameter attack decomposition “an attacker can exploit a vulnerability in the control unit in order to disable the brakes” could read: “the vehicle crashes due to the disabled brakes, an upcoming sharp curve and a slippery road.” In a similar manner, a further assignment is possible between the context-parameter attack decomposition describing the attack “the attacker can exploit the control unit and the infotainment system in order to suddenly dispense washer fluid and increase the volume of the loudspeakers to maximum,” and the hazardous situation “the vehicle is approaching a sharp curve while traveling at high speed and under poor visibility conditions, and the windshield wipers were dispensing washer fluid in an uncontrolled manner.” It should be taken into account that some context parameters in the hazardous situations depend only on the context and not on the attack decomposition; e.g., driving under poor visibility while approaching a sharp curve is generally a hazardous situation even without a (cyber) security reason. The proposed approach thus also allows generating responses even when no (cyber) security attack is recognized, but a safety-relevant situation is nevertheless present.

According to an example embodiment, a prioritization can also be carried out; thus, e.g., by means of filtering the possible safety-relevant situations or hazardous situations, the relevant or active safety-relevant situations can be obtained. The prioritization and filtering process can be carried out, in particular, based on predefined rules, such as, e.g., the severity of the hazardous situations, the probability of the hazardous situations, the potential impacts of the hazardous situations, the availability of response measures and others. The result is then a series of prioritized and filtered hazard situations requiring attention.

Furthermore, based on the response data and the relevant safety-relevant situations, at least one measure is determined. Thus, the response decompositions are determined for the relevant, and thus, if applicable, prioritized and filtered, hazard situations and the associated active context-parameter attack decompositions and the context (the context parameter values), based on which the relevant safety-relevant situations have already been determined. The response decompositions describe how to respond to the hazard situations in order to prevent safety-relevant situations. If a plurality of response decompositions are available, additional filtering can also be performed in order to determine a response that is, e.g., the “best” or most suitable, based on various factors such as, e.g., response time, probability of success, side effects such as impacts on the driver (e.g., avoidance of stress warnings), economic impacts (avoidance of vehicle damage) and others. Thus, in particular, a series of response decompositions are obtained that describe the one or more measures that can be taken in order to prevent the safety-relevant situations. Thus, at least one measure is determined based on the relevant response decompositions.

Information regarding the at least one measure is then provided, i.e., it is, e.g., announced which measure is to be carried out or which measure should be carried out. In particular, the at least one measure is initiated, i.e., implemented. The measures contemplated are, in particular, alerting measures and/or response measures. Alerting measures can be used to inform the driver, the manufacturer, the service center or other relevant parties regarding the potentially safety-relevant situation. With the aid of the response measures, it is, in contrast, possible to respond automatically, e.g., to the hazard situations, and safety-relevant situations or incidents can be prevented. The measures can be carried out automatically by the technical system or vehicle, or manually by the driver or user or other parties involved. The result is preventing safety-relevant incidents or situations in a vehicle or in another technical system during operation.

For example, in the hazard situation “the vehicle crashes due to the ineffective brakes, an upcoming sharp curve and a slippery road,” the speed could be automatically reduced to 0 km/h by controlled engine braking in order to prevent the accident, and the driver could be warned in advance (e.g., several hundred meters before the curve) regarding the possible hazard situation.

With the proposed approach according to the present disclosure, the gap between (cyber) security attacks and safety-relevant incidents or situations in vehicles or other technical systems is closed, and it provides a novel possibility for predicting and preventing potentially safety-relevant incidents caused by (cyber) security attacks.

Responses can also be generated or measures taken when no (cyber) security attack is present. The approach can thus also be applied when only non-safety-relevant context parameters are monitored (e.g., only by accident prevention based on the current weather conditions, location and the driver's health status).

In one example embodiment, the method is performed within the framework of an intrusion detection and prevention system (IDPS). In one embodiment, the method is executed within the framework of a driver assistance system (ADAS) or autonomous driving. The method or a correspondingly configured system can thus be integrated, e.g., into the stack of automated driving (AD) or an ADAS system and communicate (driving) situations to be avoided (in the near future), so that the AD/ADAS systems can mitigate potential safety risks, e.g., by selecting alternative routes/driving maneuvers or by temporarily passivating AD/ADAS functions.

If, e.g., an increased risk for malicious activation of the windshield-wiper spray system is indicated, which activation impairs the performance of the camera sensors, the automated driving system could select an inner-city route at low speed on which a simple “stop in lane” is always a safe maneuver option (in contrast to a “stop in lane” on a heavily traveled highway).

If, e.g., an increased risk for manipulated ego-telemetry signals (e.g., driving speed, yaw rate, etc.) is indicated, driver assistance functions or systems that depend on the correctness of these signals for safe operation (e.g., automated emergency braking, electronic stability control) can be temporarily passivated until the attack risk has again reached an acceptably low level.

A computing unit according to the present disclosure, e.g., a computer or server (e.g., also in the so-called cloud), or a control unit of a vehicle or of another technical system, is configured, in particular in terms of programming, to perform a method according to the invention. In particular, computations can thus also be outsourced, e.g., to the so-called cloud, wherein communication with a vehicle for relevant data is carried out via a suitable communication connection. Thus, in the underlying data being provided, data from other vehicles or systems can also be taken into account that are connected, e.g., via V2X (e.g., a “Collective Perception Message” provided by V2X).

Furthermore, the implementation of a method according to the present disclosure in the form of a computer program or computer program product having program code for performing all the method steps is advantageous because it is particularly low-cost, in particular if an executing control unit is also used for further tasks and is therefore present anyway. Finally, a machine-readable storage medium having a computer program as described above stored thereon is provided. Suitable storage media or data carriers for providing the computer program are, in particular, magnetic, optical, and electric storage media, such as hard disks, flash memory, EEPROMS, DVDs, and others. It is also possible to download a program via computer networks (Internet, intranet, etc.). Such a download can take place in a wired or wireless manner (e.g., via a WLAN network or a 3G, 4G, 5G or 6G connection, etc.).

Further advantages and embodiments of the present disclosure can be found in the description and the figures.

The present disclosure is shown schematically in the figures on the basis of exemplary embodiments and is described below with reference to the figures.

### BRIEF DESCRIPTION OF THE DRAWINGS

FIG. 1 schematically shows an example technical system in which the present disclosure can be used.

FIGS. 2A and 2B together schematically show a sequence of a method in one example embodiment.

### DETAILED DESCRIPTION OF EXAMPLE EMBODIMENTS

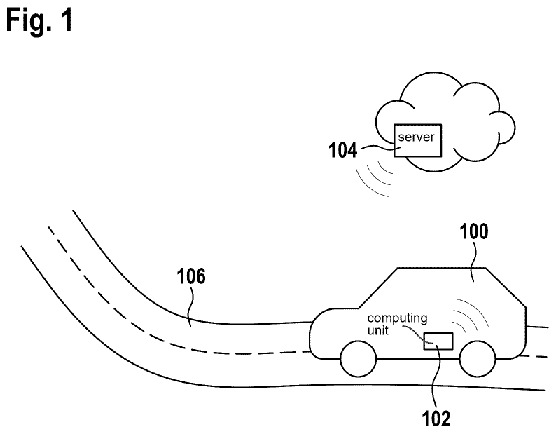

In FIG. 1, a technical system 100 configured as a vehicle is schematically shown, in which the invention can be used. The vehicle 100 comprises a computing unit 102 configured as a control unit which can be connected, e.g., via a wireless communication connection that is only indicated, to a server 104, e.g., the so-called cloud. The vehicle can travel, e.g., along a road 106, and during operation of the vehicle 100, monitoring for potentially safety-relevant situations can be carried out, as will be explained in more detail hereinafter.

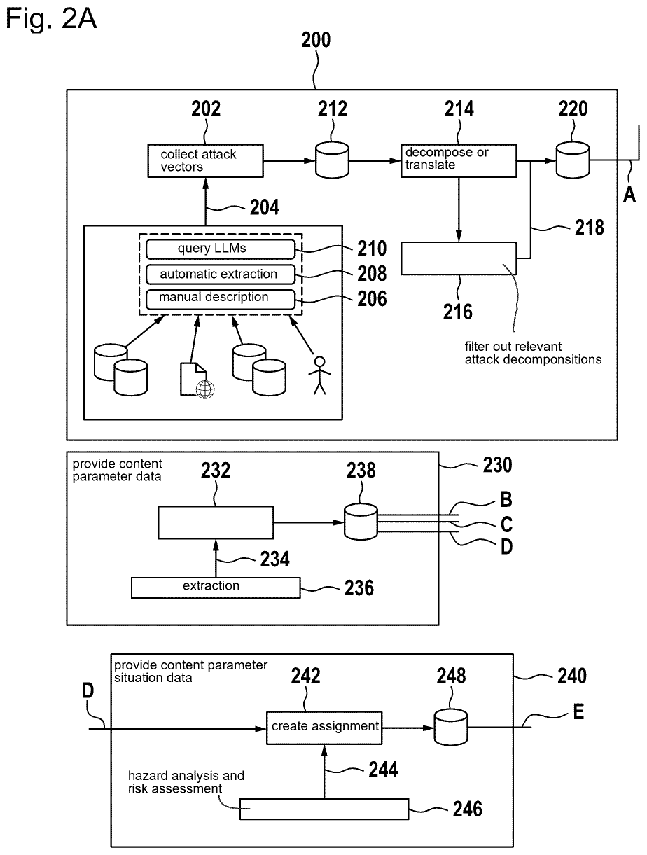

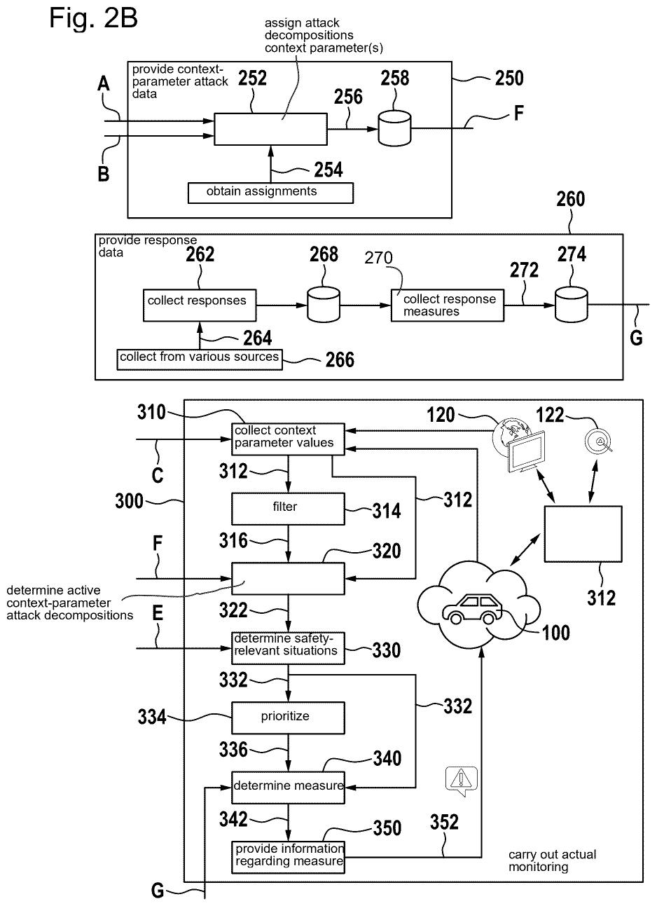

A sequence of a method therefor is shown, in one embodiment, in FIGS. 2A and 2B.

Initially, in step 200, attack decompositions can be provided. This can comprise, in particular, that initially, in step 202, a plurality of attack vectors 204 is collected. An attack vector is, in particular, as already mentioned, a description of how an attacker can exploit a vulnerability in a component in order to perform a malicious action. The attack vectors can be collected in various ways, e.g., by means of a manual description 206 by a security expert, an automatic extraction 208 from the various sources via parsers, crawlers or even by querying 210 LLMs. The result thereof is a set of attack vectors that can be stored, e.g., in a database 212.

In a step 214, these attack vectors can then be decomposed or translated into decompositions-here, attack decompositions which then comprise function blocks.

Optionally, relevant attack decompositions can be filtered out, in step 216. The attack decompositions 218 obtained, if applicable, by means of filtering can then be stored in a database 220 and thus provided for further use.

In a step 230, context parameter data are provided. For this purpose, a plurality of context parameters 234 is collected.

This can be carried out, as already mentioned, based on human inputs, online resources, analysis of the vehicle sensors or generally sensors of the technical system, internal vehicle systems or generally internal systems or components of the technical system, specifications, weather services, traffic services and the like. Generally, this can be referred to as an extraction 236. Context parameters are related to a context of the vehicle, i.e., they describe, e.g., the context of the vehicle such as driving speed, steering angle, etc. For further examples of context parameters, reference is made to the preceding explanations. The context parameters obtained in this way can then be stored in a database 238 and thus—as context parameter data—provided for further use.

In a step 240, context parameter situation data are provided. For this purpose, in step 242, an assignment between the context parameters 234 previously provided (from the database 238) and hazardous situations 244 is created. Hazard situations or hazardous situations, which can potentially lead to a safety-relevant (related to operational safety) incident in a vehicle, are collected, e.g., in a so-called “hazard analysis and risk assessment,” in step 246. However, this can also be carried out in a customary manner: the assignment of context parameters to hazard situations can be carried out, as previously, manually or by collecting data from available sources (websites, statistics, LLMs and others). The assignments obtained in this way can then be stored in a database 248 and thus—as context parameter situation data—provided for further use.

In a step 250, context-parameter attack data are provided. For this purpose, in step 252, at least a portion of the attack decompositions 218 are in each case assigned one or more context parameters 234. Corresponding assignments 254 can be obtained, as already mentioned, e.g., manually or by collecting data from available sources (websites, statistics, LLMs and others), thus generally by suitable extraction. The context-parameter attack decompositions 256 obtained in this way can then be stored in a database 258 and thus—as context-parameter attack data provided for further use.

In a step 260, response data are provided. For this purpose, in step 262, a series or a plurality of responses or response measures 264 are collected. The response measures can, as mentioned, be collected from various sources 266, e.g., safety manuals, best practices, safety reports, threat data, IDPS reports and others. The response measures can initially be stored, e.g., in a database 268.

In a step 270, the collected response measures are then decomposed in order to obtain response decompositions 272. Here, the already mentioned concept of decomposition can be used. The response decompositions 272 obtained in this way can then be stored in a database 274 and thus—as response data—provided for further use.

The above-cited steps 200, 230, 240, 250, 260 do not need to be executed sequentially, but can be executed, at least in part, in parallel. Attention must be paid only to when results of one step are needed in another step. These steps can also be repeated repeatedly or executed continuously in order to be able to maintain data that are as current as possible.

Based on the data provided in this way, the actual monitoring in the vehicle can then be carried out, in step 300. Here, initially, in step 310, context parameter values 312 are collected for at least a portion of the context parameters 234. The context parameter values obtained in this way can, in step 314, be filtered in order to obtain or determine available context parameter values 316. If no filtering is carried out, the context parameter values can be directly used further. The collection of the context parameter values can be carried out from the ongoing operation of the vehicle 100, from the Internet 120 (e.g., for weather data) or also from an IDPS 122.

Based on the context-parameter attack decompositions 256, in step 320, active (currently relevant) context-parameter attack decompositions 322 are determined.

Based on the context parameter situation data (assignment between context parameters 234 (from the database 238) and hazardous situations 244) and the available context parameter values 316, safety-relevant situations 332 are then determined for the active context-parameter attack decompositions, in step 330. A prioritization 334 can also be carried out; thus, e.g., by means of filtering the possible safety-relevant situations or hazardous situations, the relevant or active safety-relevant situations 336 can be obtained. If no filtering or prioritization is carried out, the safety-relevant situations 332 can be further used directly as the relevant ones.

Based on the response data along with the relevant safety-relevant situations, in step 340, at least one measure 342 is determined. Then, in step 350, information regarding the at least one measure is provided. In particular, the at least one measure is also initiated, in step 352. This then takes place particularly in the vehicle 100.

1-10. (canceled)

11. A method for monitoring a technical system with regard to a potentially safety-relevant situation, the method comprising the following steps:
providing context parameter data that include a plurality of context parameters that are related to a context of the technical system;
providing context parameter situation data that include assignments between the context parameters and hazardous situations;
providing context-parameter attack data that include a plurality of context-parameter attack decompositions, wherein each of the context-parameter attack decompositions corresponds to an attack decomposition to which one or more of the context parameters are assigned, wherein each of the attack decompositions includes one or more function blocks obtained by decomposing an attack vector;
providing response data that include a plurality of response decompositions, wherein each of the response decompositions include one or more of function blocks obtained by decomposing a response to a safety-relevant situation at the technical system;
determining available context parameter values for at least a portion of the context parameters included in the context parameter data;
determining, based on the context-parameter attack decompositions, active context-parameter attack decompositions;
determining, based on the context parameter situation data and the available context parameter values, safety-relevant situations that are relevant for the active context-parameter attack decompositions;
determining, based on the response data and the relevant safety-relevant situations, at least one measure; and
providing information regarding the at least one measure; and
initiating the at least one measure.

12. The method according to claim 11, wherein the context parameters include one or more of the following parameters:
speed,
steering angle,
weather data,
geolocation of the technical system,
driver or user data,
status of components of the technical system,
statistics on accidents,
interior temperature,
humidity,
volume of loudspeakers.

13. The method according to claim 11, wherein determining the available context parameter values includes determining context parameter values and then filtering the context parameter values in order to obtain the available context parameter values.

14. The method according to claim 11, wherein the determining of the active context-parameter attack decompositions includes:
determining which of the context-parameter attack decompositions can be assigned to the available context parameter values to obtain the active context-parameter attack decompositions.

15. The method according to claim 11, wherein the method is performed within a framework of an intrusion detection and prevention system.

16. The method according to claim 11, wherein the method is executed within a framework of a driver assistance system or autonomous driving.

17. The method according to claim 11, wherein the technical system is one of the following technical systems:
a vehicle,
a component or a control unit of a vehicle,
a robot or a control unit of a robot,
a building including a factory or a hospital,
a smart home,
a smart locality.

18. A computing unit configured to monitor a technical system with regard to a potentially safety-relevant situation, the computing unit configured to perform the following steps comprising:
providing context parameter data that include a plurality of context parameters that are related to a context of the technical system;
providing context parameter situation data that include assignments between the context parameters and hazardous situations;
providing context-parameter attack data that include a plurality of context-parameter attack decompositions, wherein each of the context-parameter attack decompositions corresponds to an attack decomposition to which one or more the context parameters are assigned, wherein each of the attack decompositions includes one or more function blocks obtained by decomposing an attack vector;
providing response data that include a plurality of response decompositions, wherein each of the response decompositions include one or more of function blocks obtained by decomposing a response to a safety-relevant situation at the technical system;
determining available context parameter values for at least a portion of the context parameters included in the context parameter data;
determining, based on the context-parameter attack decompositions, active context-parameter attack decompositions;
determining, based on the context parameter situation data and the available context parameter values, safety-relevant situations that are relevant for the active context-parameter attack decompositions;
determining, based on the response data and the relevant safety-relevant situations, at least one measure; and
providing information regarding the at least one measure; and
initiating the at least one measure.

19. A non-transitory machine-readable storage medium on which is stored a computer program monitoring a technical system with regard to a potentially safety-relevant situation, the computer program, when executed by a computer, causing the computer to perform the following steps comprising:
providing context parameter data that include a plurality of context parameters that are related to a context of the technical system;
providing context parameter situation data that include assignments between the context parameters and hazardous situations;
providing context-parameter attack data that include a plurality of context-parameter attack decompositions, wherein each of the context-parameter attack decompositions corresponds to an attack decomposition to which one or more the context parameters are assigned, wherein each of the attack decompositions includes one or more function blocks obtained by decomposing an attack vector;
providing response data that include a plurality of response decompositions, wherein each of the response decompositions include one or more of function blocks obtained by decomposing a response to a safety-relevant situation at the technical system;
determining available context parameter values for at least a portion of the context parameters included in the context parameter data;
determining, based on the context-parameter attack decompositions, active context-parameter attack decompositions;
determining, based on the context parameter situation data and the available context parameter values, safety-relevant situations that are relevant for the active context-parameter attack decompositions;
determining, based on the response data and the relevant safety-relevant situations, at least one measure; and
providing information regarding the at least one measure; and
initiating the at least one measure.
